(19) United States
(12) Patent Application Publication
(10) Pub. No.: US 2007/0080656 A1
(43) Pub. Date: Apr. 12, 2007

(54) Wheelchair with motor speed and torque control

(75) Inventor: James M. Koerlin, Broomfield, CO (US)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: Sunrise Medical HHG Inc.

(21) Appl. No.: 11/545,614

(22) Filed: Oct. 11, 2006

Related U.S. Application Data
(60) Provisional application No. 60/725,259, filed on Oct. 11, 2005.

(51) Int. Cl. H02P 7/00

(52) U.S. Cl. 318/432; 318/268

(57) ABSTRACT

A method varies motor torque inversely as a function of speed.

### CROSS REFERENCE TO RELATED APPLICATIONS

This application claims the benefit of U.S. Provisional Patent Application No. 60/725,259 filed on Oct. 11, 2005.

### BACKGROUND OF INVENTION

The present invention is generally related to land vehicles, and more particularly related to personal mobility vehicles. Most particularly, the invention is related to motor speed and torque control for wheelchairs.

In a basic DC motor, the speed at which the motor shaft turns is proportional to the voltage applied to the motor armature. Similarly, the current through the motor armature increases in proportion to the torque required by the load on the motor shaft. However, when operated at a fixed applied voltage but an increasing torque load, the motor exhibits a speed droop. A type of “compensation” may be used to maintain a nearly constant speed under varying torque or load conditions. This compensation is referred to as IR compensation. The IR compensation determines the degree to which motor speed is held constant as the torque or motor load changes. IR compensation is factory set for optimum motor regulation. However, if the IR compensation is set too high, then unstable or oscillatory operation of the motor will result. If set too low, then operation of the motor will be sluggish or the motor may stall.

What is needed is a manner in which a wheelchair motor control may better control motor speed and torque, without creating an unstable, oscillatory or sluggish motor operation.

### SUMMARY OF INVENTION

The present invention is directed to a motor speed and torque control for wheelchairs. A motor control varies motor torque inversely as a function of motor speed and adjusts torque by making adjustments in IR compensation.

### DESCRIPTION OF THE DRAWINGS

FIG. 1 is a side elevational view of an exemplary power wheelchair.

FIG. 2 is a schematic representation of an exemplary motor control for use with the wheelchair.

FIG. 3 is a diagrammatic representation of an example of a relationship between IR compensation and speed.

FIG. 4 is a diagrammatic representation of an example of a desired relationship between speed and torque.

### BRIEF DESCRIPTION OF THE INVENTION

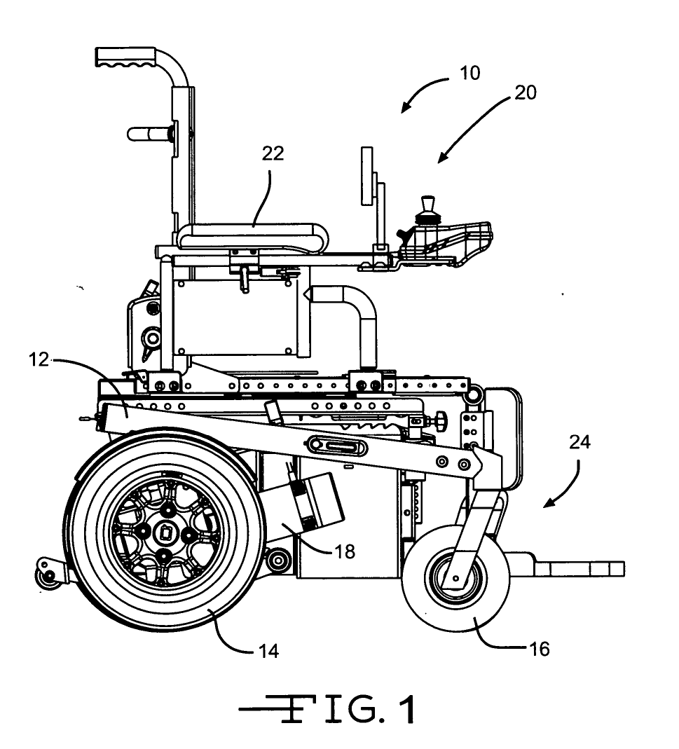

Referring now to the drawings, there is illustrated in FIG. 1 an exemplary power wheelchair, generally indicated at 10, which represents one of many wheelchair configurations with which the invention may be practiced. The exemplary wheelchair 10 may comprise a chassis, which may be inclusive of a frame 12, and which is supported for movement in relation to a supporting surface (i.e., the floor or the ground) by one or more ground engaging wheels, such as the driven wheels 14 and the non-driven caster wheels 16 shown. The driven wheels 14 may be respectively driven by a power train mounting the driven wheels 14 to the chassis. Each power train may include a drive motor 18, as shown, and associated gearbox (not shown).

The chassis is dimensioned and configured to support various wheelchair components, such as but not limited to a battery tray (not shown) for supporting one or more batteries for providing power to the wheelchair 10, a wiring assembly for supplying power to, and communication between, various electronic components of a control system and optional electronics, and a seat assembly 20 for supporting a wheelchair occupant. The seat assembly 20 may be of the type that tilts and/or lifts and reclines, and preferably has opposing armrests 22 for supporting the wheelchair occupant's arms and leg rests 24 for supporting the wheelchair occupant's legs. The armrests 22 may support one or more user interface devices, such as a hand control and a control display, such as an LED and/or liquid crystal display. The various electronic components may include a motor control for controlling the drive motors 18 and various other general functions of the wheelchair 10, a specialty input module for controlling switch-type inputs (e.g., Sip-and-Puff, ASL, Switch-It and Tash discrete switches, and a head control), a multi actuator control (MAC) for controlling one or more actuators (e.g., seat tilt, shear, lift and recline actuators and leg rest actuators), and an environmental control module (ECM) for interfacing with environmental devices, including but not limited to infrared devices and radio frequency devices.

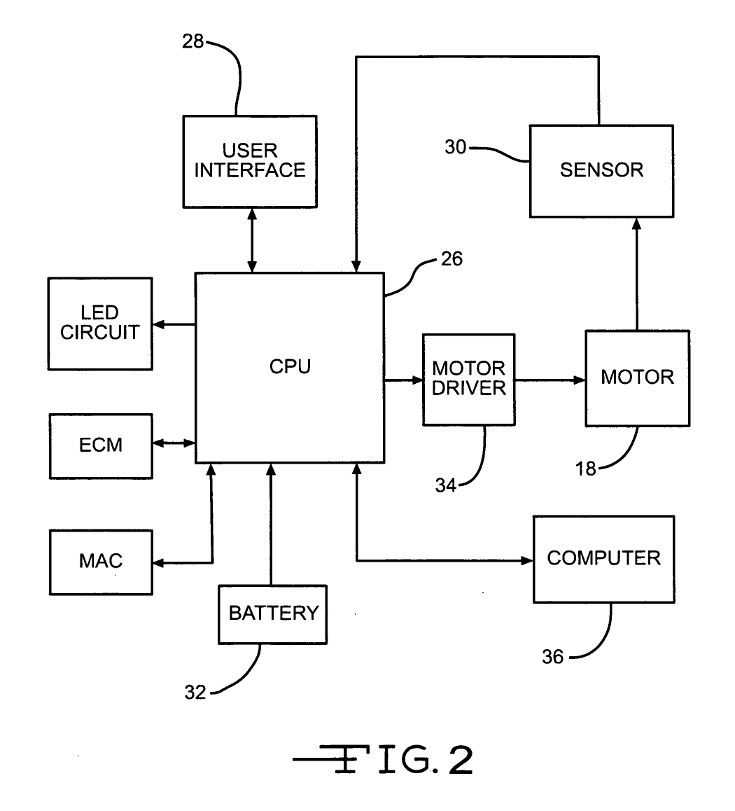

FIG. 2 shows components of the motor control and the data passing between the components. The exemplary motor control may comprise a central processing unit (CPU) 26 and associated circuitry, and there may be connected to a user interface device 28, a sensor 30, a battery 32, a motor driver 34, and the motor 18. Circuitry for the motor control may be housed in a control box (not shown) that is, preferably, either integral with the power train/gearbox or encased in a separate enclosure mounted on the chassis.

The motor control operates through the CPU 26, which may be implemented as a programmable microprocessor. The motor control may utilize desired dynamic or drive profile. The drive profile may be programmed into the CPU 26 and may be specifically configured to meet the needs of the individual wheelchair user. The CPU 26 may be programmable through the use of a PC-based computer 36 having associated memory storage. Resident on the computer 36 may be a design tool, such as a PC setup station (PCSS), for specifying and downloading these control maps to the CPU 26. An infrared link may facilitate data transfer between the CPU 26 and the external computer 32.

The various drive profiles may be accessed by the user through the use of the user interface device 28 between the user and the CPU 26. The user interface device 28 may be provided with a switch, such as a mode switch, that allows the user to select between the various drive profiles pre-programmed into the CPU 26. The display may be used to indicate which drive profile has been selected by the user. Once the user selects the desired drive profile, the CPU 26 is ready to compute the desired system output or control signal for controlling the motor 18.

The motor control operates to provide a control signal to the motor 18 as follows. The sensor 30 measures a current or other parameter indicative of torque, and transmits this value to the CPU 26. The CPU 26 accepts the measured value input from the sensor 30 and a command input from the user interface device 28, and in response, outputs a control signal to the motor 18 via the motor driver 34. The motor control uses the measured value to transmit an appropriate control signal to the motor 18. The control signal contains magnitude and polarity information which are presented to the motor driver 34 to produce an appropriate motor output. The motor driver 34 converts the control signal into a voltage of the appropriate magnitude and polarity to be applied to the motor 18. The magnitude and polarity of the voltage dictate to the speed and direction in which the motor is operated.

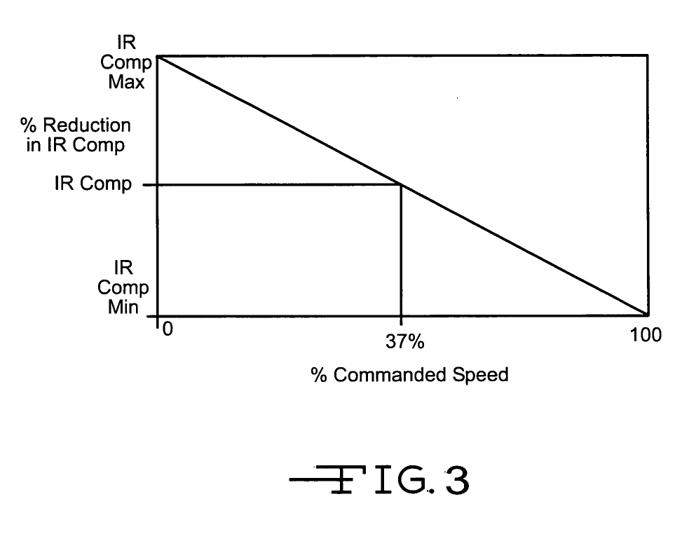

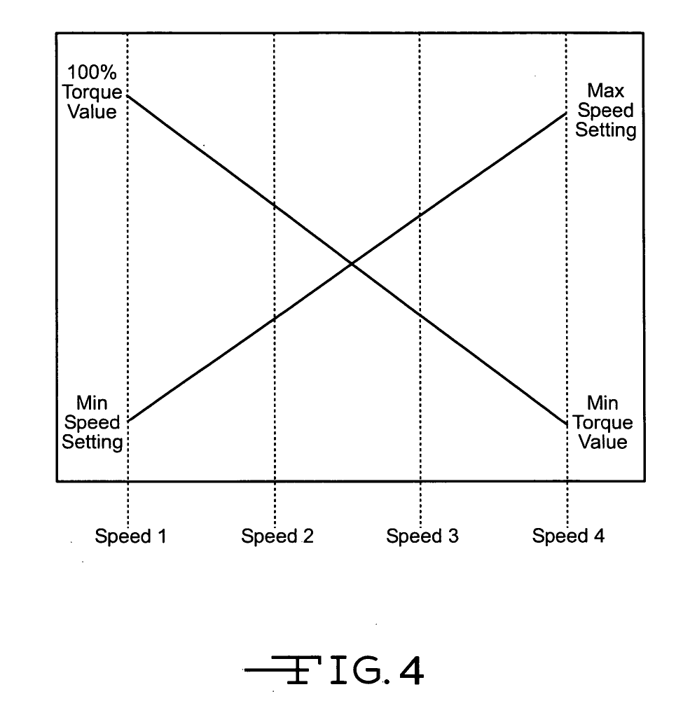

The user interface device 28 commands a specific speed of the motor 18 via motor control based on displacement of the user interface device 28 and the programmed speed of that drive profile. The motor control calculates the necessary voltage to apply to the motor 18 in order to achieve that commanded speed. This calculation is based on IR compensation 38. The motor 18 is driven at a speed based on the applied voltage in relationship to the displacement of the user interface device 28. There is no specific sensor that returns actual commanded speed to the motor control in this case. As such, the speed may vary as load at the driven wheel 14 changes. When the motor encounters torque of a load, the current drawn by the motor will increase. As the speed varies while driving, an adjustment algorithm 40 adjusts the IR compensation. Maximum and minimum IR compensation settings, shown in FIG. 3, can be set by a wheelchair dealer or clinician in the field in order to customize this relationship to the driving needs of the wheelchair user. Once the high and low torque values are set in a drive profile, the adjustment algorithm 40 may vary the torque, preferably within established maximum and minimum settings, in proportion to the commanded wheelchair speed, as shown FIG. 4.

The IR compensation is used to overcome a change in current drawn by the motor 18 due to a corresponding change in torque or load on the motor 18. When torque or load on the motor 18 increases, the current drawn by the motor 18 correspondingly increases, as measured by the sensor 30, and the IR compensation provides positive feedback that causes a gain in the voltage applied to the motor 18 in response to current increases. Conversely, when torque or load on the motor 18 decreases, the IR compensation provides positive feedback that causes attenuation in the voltage applied to the motor 18 in response to current decreases. This will help to stabilize the motor's speed as the torque or load on the motor 18 changes. The amount of change in the voltage applied to the motor is determined by the IR compensation setting. Normally, if the IR compensation is set too high, it will be too responsive, that is, an increase in motor voltage will cause an undesirable increase in motor current, which will cause a further increase in motor voltage, and so on. This would cause an unstable or oscillating condition that is undesirable in the operation of the motor. However, if the IR compensation is set too low, it will not be responsive enough, and the motor operation will be sluggish, or the motor 18 will stall.

Torque demand changes with changes in speed of the wheelchair. At higher speeds, less torque is required due to momentum and inertia. At lower speeds, more torque is required due to the lack of momentum and inertia. The motor control varies torque inversely as a function of speed. To control the torque of a motor, IR compensation is used. According to the present invention, a torque adjustment is accomplished by making adjustments in the IR compensation. As the IR compensation is decreased, the motor control compensates less or makes smaller changes in voltage gain for increases in current. This effectively reduces torque of the motor.

The torque should increase as the speed decreases, as shown in FIG. 4. In Speed 1 (e.g., a minimum operating speed of the motor 18), selection of the torque should be maximized (e.g., approximately 100%) and the speed should be minimized (e.g., approximately 25% of the Max Speed setting). In Speed 4 (e.g., a maximum operating speed of the motor 18), selection of the torque should be minimized (e.g., approximately 20%) while the speed should be maximized (i.e., approximately 100% of Max Speed setting). Speed and torque preferably vary linearly in the other two speed settings (e.g., Speed 2 and 3), as shown in the drawing. These settings may be factory settings and/or adjusted in the field by dealers, clinicians or the user.

It should be appreciated that the levels of speed shown and described above may be discrete levels of speed increases or be representative of continuous increases in speed. It should also be noted that the aforementioned values (e.g., 20, 25, and 100%) are provided for illustrative purposes, and that the invention may be practiced with other suitable values.

It should be appreciated that for a given displacement of the user interface device 28, a given voltage is applied to be drive motor 18 and, based on the motor specifications and characteristics, a given current is expected to be drawn by the motor for a given torque or load on the motor 18. Actual current drawn by the motor 18 is compared to the given current. A difference in the given and actual current represents a change in torque or load on the motor 18 and a change in the speed of the motor 18. This triggers IR compensation to adjust the voltage applied to the motor 18 until the given and actual current are the same, which is a reflection that the given and actual motor speed are the same. An adjustment is provided to adjust IR compensation settings inversely to the speed that the motor 18 is operated so that IR compensation settings decrease with increases in speed and increase with decreases in speed. As a correlation, adjustments in IR compensation trigger a corresponding adjustment in torque. Adjustments in IR compensation may be based on factory settings and/or based on parameters programmed into the wheelchair 10 in the field by dealers, clinicians or the user.

The adjustment algorithm 40 is another way to help create an optimal ride. It ensures that sufficient power is readily available at low speeds as needed by the wheelchair to clear doorstops or climb obstacles. At high speeds, the same power is available in more controlled amounts, which prevents overcompensation that often contributes to erratic wheelchair performance.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A wheelchair motor control for varies motor torque inversely as a function of motor speed, wherein a torque adjustment is accomplished by making adjustments in the IR compensation of the motor control.

2. A method of controlling a wheelchair that has a frame, wheels including driven wheels, motors connected to the driven wheels, a battery, and a control configured to apply power from the battery to the motors, the method comprising:
applying a voltage to the motors to drive the motors;
measuring the current drawn by the motors;
comparing the measured current with an expected current value;
modifying the voltage applied to the motors in response to a difference in the measured current and the expected current value, wherein the manner is which the voltage is modified is adjusted in relation to motor speed.

3. The method of claim 2 in which the modification of the voltage includes increasing the voltage one rate of voltage increase when the speed of the wheelchair is high and at a second, higher rate of voltage increase when the speed of the wheelchair is low.

4. The method of claim 2 in which the modification of the voltage includes an IR compensation that is adjustable in relation to a torque load on the motor.
